(19) United States
(12) Patent Application Publication
(10) Pub. No.: US 2019/0188663 A1
(43) Pub. Date: Jun. 20, 2019

(54) METHOD FOR RELAYING PAYMENT USING REPRESENTATIVE CARD AND PAYMENT GATEWAY SERVER

(71) Applicant: Hyundai Card Co., Ltd., Seoul (KR)

(72) Inventors: Jong Yoon KIM, Seoul (KR); Woo Kyung CHANG, Seoul (KR); Bom Shik KIM, Seoul (KR); Joo Yun LEE, Seoul (KR); Myeong Suk CHOI, Seoul (KR); Dong Chul KIM, Gimpo-si (KR); Sang Ok KIM, Seoul (KR); Bo Rim LEE, Seoul (KR); Jae Kyung LEE, Seoul (KR)

(21) Appl. No.: 15/891,938

(22) Filed: Feb. 8, 2018

(30) Foreign Application Priority Data
Dec. 19, 2017 (KR) 10-2017-0175534

(51) Int. Cl. G06Q 20/10; G06Q 20/34; G06Q 20/40

(52) U.S. Cl. CPC G06Q 20/105; G06Q 20/401; G06Q 20/3555; G06Q 20/341

(57) ABSTRACT

Provided are a method of relaying, by a payment gateway server, a payment using a representative card connected to a plurality of general cards, the method comprising steps of: (a) acquiring card information of a card set as a payment card among the plurality of general cards connected to the representative card when a payment approval is requested using the representative card; and (b) requesting the payment approval to a card company server using the acquired card information of the payment card and processing such that the payment approval made using the payment card is completed.

### CROSS-REFERENCE TO RELATED APPLICATION

This application claims priority to and the benefit of Korean Patent Application No. 2017-0175534, filed on Dec. 19, 2017, the disclosure of which is incorporated herein by reference in its entirety.

### BACKGROUND

### 1. Field of the Disclosure

The present disclosure relates to a method of relaying a payment using a representative card and a payment gateway server, and more particularly, a method of relaying a payment and a payment gateway server, in which a plurality of general cards issued by respective card companies are registered to connect the plurality of general cards to a representative card so that when a payment approval is requested using the representative card, the payment approval is processed using a card that is set as a payment card among the general cards connected to the representative card.

### 2. Discussion of Related Art

Recently, as the use of cards is widespread and cards with various benefits are being released by card companies, more and more cards are being issued to users.

With the increase in the number of cards issued to a user, there is a hassle in carrying several cards and harm from card loss and theft.

Accordingly, a method of using a plurality of cards through a card by connecting a plurality of cards with a card has been suggested. However, only cards issued by the same card company are connectable with each other, so a user using a plurality of cards issued by different card companies needs to carry one or more card per card company, and thus the above discussed hassle and issues are still restricted from being resolved.

Accordingly, there is an increasing demand for being able to conveniently use a plurality of cards through a card, irrespective of card companies, and an urgent need to resolve the above discussed issues and improve user convenience.

### SUMMARY OF THE DISCLOSURE

The present disclosure is directed to a method of relaying a payment and a payment gateway server, in which a plurality of general cards issued by respective card companies are registered to connect the plurality of general cards to a representative card so that when a payment approval is requested using the representative card, the payment approval is processed using a card that is set as a payment card among the general cards connected to the representative card.

The technical objectives of the present disclosure are not limited to the above, and other objectives may become apparent to those of ordinary skill in the art based on the following descriptions.

According to one aspect of the present disclosure, there is provided a method of relaying, by a payment gateway server, a payment using a representative card connected to a plurality of general cards, the method including steps of: acquiring card information of a card set as a payment card among the plurality of general cards connected to the representative card when a payment approval is requested using the representative card; and requesting the payment approval to a card company server using the acquired card information of the payment card and perform processing such that the payment approval made using the payment card is completed.

The method may further include, before step (a), registering a plurality of general cards previously issued to a user through respective card companies to connect the plurality of general cards to the representative card.

The method may further include, before step (a), transmitting a list of the general cards connected to the representative card to a user terminal; and when a card is selected from the list of the general cards, processing such that the selected card is set as the payment card.

Step (a) may include: verifying whether the card used for requesting the payment approval is the representative card, and when it is verified that the payment approval has been requested using the representative card, acquiring the information of the payment card.

Step (b) may include identifying a card company of the payment card and request the payment approval to the identified card company.

According to another aspect of the present disclosure, there is provided a payment gateway server comprising: a card information acquiring unit configured to acquire card information of a card set as a payment card among a plurality of general cards connected to a representative card when a payment approval is requested using the representative card; and a payment approval requesting unit configured to request a payment approval to a card company server using the acquired card information of the payment card and to perform processing such that the payment approval using the payment card is completed.

The payment gateway server may further include: a card connection registration unit configured to register a plurality of general cards previously issued to a user through respective card companies to connect the plurality of general cards to the representative card.

The payment gateway server may further include: a payment card setting unit configured to transmit a list of the general cards connected to the representative card to a user terminal, and when a card is selected from the list of the general cards, processing such that the selected card is set as the payment card.

The card information acquisition unit may verify whether the card used for requesting the payment approval is the representative card, and when it is verified that the payment approval is requested using the representative card, may acquire the information of the payment card.

The payment approval requesting unit may identify a card company of the payment card and request the payment approval to the identified card company.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a diagram illustrating a payment system according to an embodiment of the present disclosure;

FIG. 2 is a block diagram illustrating a configuration of a payment gateway server according to an embodiment of the present disclosure;

FIG. 3 is a diagram illustrating a process of connecting a representative card to general cards and setting a payment card among the general cards connected to the representative card according to an embodiment of the present disclosure; and

FIG. 4 is a diagram illustrating a process of performing a payment using a representative card according to an embodiment of the present disclosure.

### DETAILED DESCRIPTION OF EXEMPLARY EMBODIMENTS

Hereinafter, embodiments of the present disclosure will be described in detail with reference to the accompanying drawings. The present disclosure may be embodied in various ways, and is not to be construed as limited to the embodiments set forth herein. In the drawings, parts irrelevant to the description have been omitted to clarify the explanation, and the same reference numerals have been used to designate the same elements through the whole specification.

It should be understood that when an element is referred to as being “connected” or “coupled” to another element, the element may be directly or indirectly connected or coupled to the other element, or intervening elements may be present. The terms “comprises,” “includes,” “comprising,” and/or “including” mean that the described components, steps, operations, and/or elements are included and do not preclude the addition or presence of one or more other components, steps, operations, and/or elements unless the context dictates otherwise.

Hereinafter, embodiments of the present disclosure will be described in detail with reference to the accompanying drawings.

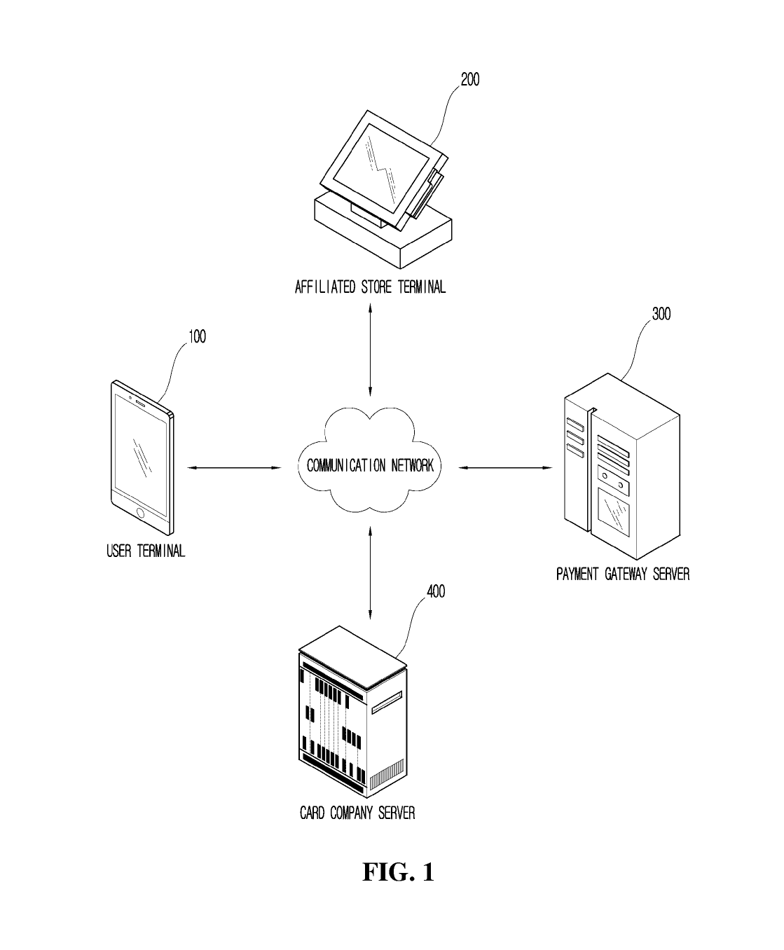

FIG. 1 is a diagram illustrating a payment system according to an embodiment of the present disclosure.

Referring to FIG. 1, the payment system according to the embodiment of the present disclosure may include a user terminal 100, an affiliated store terminal 200, a payment gateway server 300, and a card company server 400 that may communicate with each other through a communication network.

First, the communication network may be implemented without being limited to any communication scheme, such as wired communication or wireless communication. The communication network may be implemented through various communication networks such as a local area network (LAN), a metropolitan area network (MAN), a wide area network (WAN), and the like.

The user terminal 100 may include all types of handheld wireless communication devices, which may be connected to an external server through a network, such as a mobile phone, a smart phone, a personal digital assistant (PDA), a portable multimedia player (PMP), a tablet personal computer (tablet PC), and the like. In addition, the user terminal 100 may include a communication device, which may be connected to an external server through a network, such as a desktop PC, a table PC, a laptop PC, and an Internet protocol television (IPTV) including a set top box.

The user terminal 100 may be provided with an application for managing a representative card.

According to the embodiment of the present disclosure, the representative card may be issued to a user as a physical card of which card information, such as a card number, validity, and the like, is registered. Unlike a general card having a payment function, the representative card itself does not have a payment function, and at a time of payment approval using the representative card, the payment approval may be processed through a card set as a payment card among general cards connected to the representative card. That is, when a payment approval is requested using the representative card, the payment approval is processed by the payment card rather than the representative card.

A representative card management application is an application provided by a PG company that operates the payment gateway server 300, and may provide various services related to the representative card, such as registering a representative card, connecting a general card to the representative card, setting a payment card, and the like.

The user terminal 100 may download and install the representative card management application through an application store, and in detail, when the PG company operating the payment gateway server 300 registers the representative card management application on the application store, the user terminal 100 may download the application registered in the application store and install the downloaded application in a memory of the user terminal 100.

The following description will be made in relation to a process performed by the representative card management application installed in the user terminal 100, but it should be understood that the whole process may be performed by the user terminal 100 itself without the representative card management application.

The user terminal 100 may perform a process of registering a representative card when the representative card management application is initially executed, and may perform a process of setting a payment card after the representative card is registered. Detailed descriptions thereof will be given below with reference to FIG. 3.

The affiliated store terminal 200 may recognize a magnetic stripe (MS) or an integrated circuit (IC) chip inside a card through a card reader connected to the affiliated store terminal 200 to identify card information, and may transmit a payment approval request including the identified card information to the payment gateway server 300.

The payment gateway server 300 may relay a card payment approval while connected with the affiliated store terminal 200 and the card company server 400. To this end, the PG company operating the payment gateway server 300 may make a contract with a card company on behalf of a store having difficulty with directly making a merchant contract with the card company, and may receive a commission after handling business such as card payment approvals, card statement purchases, and the like.

The payment gateway server 300 may, when a registration of a representative card is requested by the user terminal 100 through the representative card management application, identify information about a user and register information of the representative card.

The payment gateway server 300 may, when the connection of a general card is requested by the user terminal 100 through the representative card management application, connect a general card previously issued to the user to the representative card, and thus register information of the general card connected to the representative card.

In the connecting of the card, the payment gateway server 300 may connect a plurality of general cards previously issued to the user through respective card companies to the representative card, and thus register the plurality of general cards. That is, the payment gateway server 300 may connect the plurality of general cards previously issued to the user through different card companies to a representative card, irrespective of card companies, and thus register the plurality of general cards.

After the connecting of the cards, the payment gateway server 300 may, when the setting of a payment card is requested by the user terminal 100 through the representative card management application, set a payment card among the general cards connected to the representative cards, and thus register the payment card.

The payment gateway server 300 may register information about the representative card, information about the general card connected to the representative card, information about the payment card, and the like, and store the pieces of information in a database. The database may be implemented as an independent device and connected to the payment gateway server 300, or may be implemented so as to be included in the payment gateway server 300.

The payment gateway server 300 may, when a payment approval is requested using the representative card, check a card that is set as the payment card among the general cards connected to the representative card and acquire information about the payment card, and may request the payment approval to the card company server 400 using the acquired information about the payment card.

The card company server 400 is a server operated by a card company that has issued the general card, and may store information about a general card issued to the user in a database and manage the information.

The card company server 400 may, when a payment approval is requested by the payment gateway server 300 using the payment card, compare the payment card information included in the payment approval request with the general card information included in the database and perform a payment approval procedure.

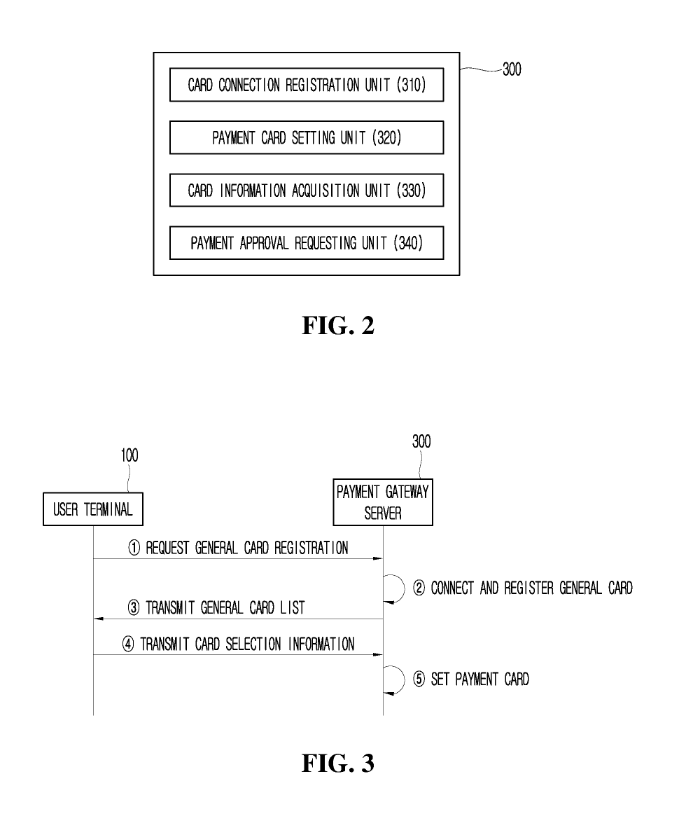

FIG. 2 is a block diagram illustrating a configuration of the payment gateway server 300 according to an embodiment of the present disclosure.

Referring to FIG. 2, the payment gateway server 300 may include a card connection registration unit 310, a payment card setting unit 320, a card information acquisition unit 330, and a payment approval requesting unit 340.

First, the user terminal 100 may have the representative card management application installed therein, and a representative card may be issued to a user, and thus information about the representative card issued to the user is registered in the database of the payment gateway server 300.

When the representative card is issued, the payment gateway server 300 may match and store information of a user who has requested an issuance of the representative card and information of the issued representative card in the database.

The card connection registration unit 310 may connect the representative card registered in the database of the payment gateway server 300 to the general card previously issued to the user and may thus register the general card. In this case, the card connection registration unit 310 may connect a plurality of general cards issued to the user through respective card companies to the representative card and may thus register the plurality of general cards.

For example, when a card A is issued by a first card company to a user, and a card B is issued by a second card company, the card connection registration unit 310 may connect the card A and the card B to the representative card and thus register the card A and card B.

That is, the card connection registration unit 310 may connect a plurality of general cards previously issued to the user through respective card companies to a representative card, irrespective of card companies, and may thus register the plurality of general cards.

The card connection registration unit 310 may automatically connect all cards issued to the user to the representative card without selection by a user, or may select a card that satisfies a particular condition among cards previously issued to the user and connect the selected card to the representative card.

In addition, the card connection registration unit 310 may connect, among cards previously issued to the user to the representative card, only a card for which an input is received by a user's selection through the representative card management application.

For example, the card connection registration unit 310 may receive information about a general card directly input by the user from the user terminal 100 and register the general card to connect the general card to the representative card, and may receive information about a general card extracted from an image obtained by capturing an image of the general card and register the general card to connect the general cards to the representative card.

The payment card setting unit 320 may generate a list of the general cards connected to the representative card, on the basis of pieces of information about the plurality of general cards connected to the representative card. That is, the payment card setting unit 320 may generate a list of general cards, which is a group of candidate cards connected to the representative card that may be set as payment cards.

For example, the payment card setting unit 320 may generate a list of general cards including a card A and a card B that are connected to the representative card.

The payment card setting unit 320 may, when a card is selected from the list of the general cards, perform processing such that the selected card is set as a payment card of the representative card. In this case, the payment card setting unit 320 may match and store information about the general card set as the payment card of the representative card and information about the representative card.

For example, in a list of general cards including a card A issued by a first card company and a card B issued by a second card company, when the card A is selected as a payment card, the payment card setting unit 320 may perform processing such that the card A is set as the payment card of the representative card.

Although only one general card is described as being set as the payment card in the above, a plurality of general cards may be set as payment cards.

When a plurality of general cards are set as payment cards, conditions for using the payment cards may be additionally set in the respective payment cards. Various conditions may be set for using a payment card, including a payment time, a payment date, a payment amount, an affiliated store type, an affiliated store business category, and the like.

For example, when a card A, a card B, and a card C are set as payment cards for a representative card, the card A may be a default payment card, which does not have an additional payment card usage condition, the card B may be set to have a business categorization of “convenience store” as a payment card usage condition, and the card C may be set to have a business categorization of “restaurant” as a payment card usage condition. In this case, when the representative card is used in a convenience store, the card B may be set as the payment card, and when the representative card is used in a restaurant, the card C may be set as the payment card, and when the representative card is used in a place other than a convenience store and a restaurant, the card A may be set as the payment card.

The payment gateway server 300 may acquire information about a card set as the payment card among the general cards connected to the representative card.

In detail, when a payment approval is requested by the affiliated store terminal 200, the payment approval requesting unit 340 may receive a payment approval request from the affiliated store terminal 200. The card information acquisition unit 330 may verify whether a card used for requesting the payment approval is a representative card, on the basis of the card information included in the payment approval request, and may acquire the information about the payment card when it is verified that the payment approval is requested using the representative card.

When the payment card information is acquired, the card information acquisition unit 330 may acquire the payment card information registered by the payment card setting unit 320 by referring to the database of the payment gateway server 300.

The payment approval requesting unit 340 may receive the payment approval request from the affiliated store terminal 200 and transmit the received payment approval request to the card company server 400.

In detail, the payment approval requesting unit 340 may receive the payment approval request, which is made using the representative card, from the affiliated store terminal 200, and when the card information acquisition unit 330 acquires the payment card information, may transmit the payment approval request to the card company server 400 using the acquired payment card information.

The payment approval requesting unit 340 may identify a card company of the payment card on the basis of the payment card information and request the payment approval to the card company server 400 of the identified card company.

For example, when a card A issued by a first card company is set as a payment card, the payment approval requesting unit 340 may identify that the first card company is a card company of the payment card through the payment card information, and may transmit the payment approval request to a server of the first card company.

FIG. 3 is a diagram illustrating a process of connecting general cards to a representative card and setting a payment card among the general cards connected to the representative card according to an embodiment of the present disclosure.

First, a user using a plurality of general cards may apply for issuance of a representative card. In this case, the user may apply for the representative card by directly visiting a card company, or by accessing a Web page or an application through the user terminal 100, or by using an automated response service (ARS) or making a phone call to a service associate.

According to the embodiment of the present disclosure, the user terminal 100 may apply for a representative card through the representative card management application provided by the payment gateway server 300.

For example, when the representative card management application is executed in the user terminal 100, a representative card issuance application menu may be provided, and a representative card issuance application procedure may be performed according to menu selection.

A representative card issuance task may be directly processed by the PG company operating the payment gateway server 300, or may be processed through the card company operating the card company server 400.

The payment gateway server 300 or the card company server 400 may verify information about the representative card issuance application, determine whether to issue a representative card, and when a representative card issuance condition is satisfied, may issue the representative card. For example, it is determined that the representative card issuance condition is satisfied when the general card previously issued to the user is a total of two or more, and a representative card may be issued to the user.

When issuance of a representative card is applied, the representative card may be requested to be issued as at least one of a plastic card and a mobile card. When the representative card is requested to be issued as a plastic card, the issued representative card may be delivered to the user by mail, and when the representative card is requested to be issued as a mobile card, the representative card may be issued through the representative card management application.

The representative card issued to the user may be a physical card of which card information, such as a card number, validity, and the like, are registered. Although the representative card itself does not have a payment function, a general card set as a payment card among general cards connected to the representative card may perform a payment function on behalf of the representative card.

When the PG company operating the payment gateway server 300 issues the representative card, the payment gateway server 300 may register and store information about the representative card in the database at a time of issuance of the representative card, and when the card company operating the card company server 400 issues the representative card, the payment gateway server 300 may register and store information about the representative card, which is received from the card company server 400, in the database.

When the information about the representative card is registered, the payment gateway server 300 may match and store information about a user who has requested an issuance and information about an issued representative card in the database.

After the representative card is issued to the user, in an operation (1) of requesting the registering of a general card, the user terminal 100 may transmit, to the payment gateway server 300, a request to register a general card that is to be connected to the representative card issued to the user. Here, the general card registering request may be a request for connecting a general card previously issued to the user to the representative card registered in the payment gateway server 300, and may include at least one of information about the representative card and information about the user.

The payment gateway server 300 may acquire information about the general card to be connected to the representative card according to the general card registering request. In this case, the payment gateway server 300 may acquire pieces of information about a plurality of general cards previously issued to the user, irrespective of card companies.

According to the embodiment of the present disclosure, the payment gateway server 300 may receive information about the general card from the user terminal 100.

For example, when the representative card management application is executed in the user terminal 100, a menu of a general card registering request may be provided, and a general card registering procedure may be performed according to menu selection. Pieces of information about a plurality of general cards issued to the user, such as information about a card A issued by a first card company, information about a card B issued by a second card company, and the like, may be requested to be registered.

When registering information about a general card is requested and when the information about the general card is directly input by the user, the user terminal 100 may transmit the input information about the general card to the payment gateway server 300, and when information about a general card is extracted from an image obtained by capturing an image of the general card, the user terminal 100 may also transmit the extracted information about the general card to the payment gateway server 300.

According to another embodiment of the present disclosure, the payment gateway server 300 may receive and acquire information about a general card from the card company server 400.

In detail, the payment gateway server 300 may acquire user information that matches information about the representative card from the database and transmit, to the card company server 400, a request for general card information, the request including the acquired user information. In this case, the card company server 400 may acquire information about a general card previously issued to the user, on the basis of the user information, and transmit the acquired information about the general card to the payment gateway server 300.

When information about a general card is requested, the payment gateway server 300 may transmit requests for general card information to the plurality of card company servers 400 and receive respective pieces of information about general cards from the plurality of card company servers 400.

For example, when a user has a card A issued by a first card company, and has cards B and C issued by a second card company, the payment gateway server 300 may transmit requests for general card information to first, second, and third card company servers, and may receive information about the card A from the first card company server and receive pieces of information about cards B and C from the second card company server. Since information is not received from the third card company server, it is recognized that no general card has been issued to the user by the third card company server.

In an operation (2) of connecting and registering a general card, the payment gateway server 300 may connect a general card previously issued to the user to the representative card, on the basis of the information about the general card acquired from the user terminal 100 or the card company server 400, and may thus register the general card. In this case, the payment gateway server 300 may register a plurality of general cards previously issued to the user by respective card companies to connect the plurality of general cards to the representative card.

For example, when information about a card A issued to the user by a first card company and information about a card B issued to the user by a second card company are acquired, the payment gateway server 300 may register the card A and the card B to connect the card A and the card B to a representative card, even though the card companies are different from each other.

According to the embodiment of the present disclosure, the payment gateway server 300 may automatically register all cards previously issued to the user to connect all of the cards to the representative card and also may register only a card that satisfies a particular condition among the cards previously issued to the user to connect only that card to the representative card, without selection by the user, through the information about the general card acquired according to the general card registering request.

According to another embodiment of the present disclosure, the payment gateway server 300 may connect only a card selected by a user among the cards previously issued to the user to the representative card. For example, a list of cards previously issued to a user may be displayed through the representative card management application executed in the user terminal 100, and when at least one card is selected from the list of the issued cards, the payment gateway server 300 may register the selected card to connect the selected card to the representative card.

In an operation (3) of transmitting a list of general cards, the payment gateway server 300 may transmit a list of general cards connected to the representative card to the user terminal 100. That is, the payment gateway server 300 may transmit, to the user terminal 100, the list of the general cards, which is a group of candidate cards connected to the representative card that may be set as payment cards.

According to the embodiment, the payment gateway server 300 may, when any of the general cards connected to the representative cards is set as a payment card, inform the user terminal 100 that there is a need to set a payment card of the representative card by transmitting the list of the general cards to the user terminal 100.

According to another embodiment, the payment gateway server 300 may, when a payment card setting request from the user terminal 100 is requested, transmit to the user terminal the list of the general cards for payment card setting.

In an operation (4) of transmitting card selection information, the user terminal 100 may display, through the representative card management application, the list of the general cards connected to the representative card, and when a card is selected from the list of the general cards, transmit card selection information to the payment gateway server 300.

In an operation (5) of setting a payment card, the payment gateway server 300 may perform processing such that the card selected from the list of the general cards is be set as a payment card of the representative card, on the basis of the card selection information.

For example, in a list of general cards including a card A issued by a first card company and a card B issued by a second card company, the card A may be selected as a payment card, and in this case, the payment gateway server 300 may perform processing such that the card A is set as a payment card of the representative card.

In a state in which the card A is set as the payment card of the representative card, when the card B is selected as a payment card through the representative card management application, the payment gateway server 300 may perform processing such that the payment card is converted from the card A to the card B.

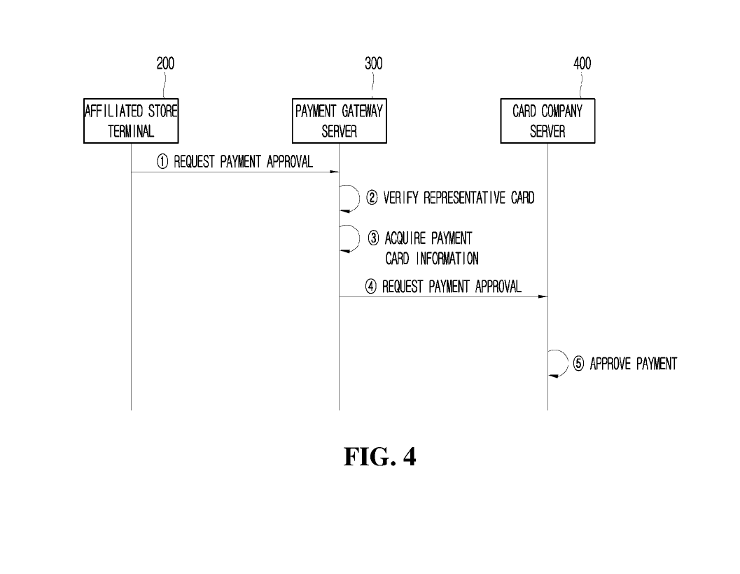

FIG. 4 is a diagram illustrating a process of performing a payment using a representative card according to an embodiment of the present disclosure.

First, a user may request a card payment using a representative card. In this case, when the card payment is requested online, information about the representative card is input online and thus the card payment is requested. When the card payment is requested offline, the representative card is recognized by the affiliated store terminal 200 and thus the card payment is requested.

When the representative card is a plastic card, the affiliated store terminal 200 may recognize the plastic card through a card recognition unit included in the affiliated store terminal 200 and acquire information about the representative card, and when the representative card is a mobile card, the affiliated store terminal 200 may recognize barcode information corresponding to the mobile card through a card recognition unit included in the affiliated store terminal 200 and acquire information about the representative card.

Then, in an operation (1) of requesting a payment approval, the affiliated store terminal 200 may transmit to the payment gateway server 300 a payment approval request including the card information recognized by the affiliated store terminal 200. To this end, a store at which the affiliated store terminal 200 is installed has already made a merchant contract with the PG company operating the payment gateway server 300, and when the card payment approval is requested through the affiliated store terminal 200, the affiliated store terminal 200 may transmit the card payment approval request to the payment gateway server 300.

When the payment approval is requested by the affiliated store terminal 200, in an operation (2) of verifying a representative card, the payment gateway server 300 may verify whether the card used for requesting the payment approval is the representative card.

That is, the payment gateway server 300 may check card information included in the payment approval request and verify whether the payment approval has been requested using the representative card.

The payment gateway server 300 may, when it is verified that the payment approval has been requested by a general card other than the representative card, transmit the payment approval request using the general card to the card company server 400.

The payment gateway server 300 may, when it is verified that the payment approval has been requested using the representative card, acquire information about a card set as a payment card among a plurality of general cards connected to the representative card in an operation (3) of acquiring payment card information.

In the acquiring of the information about the payment card, the payment gateway server 300 may refer to information about the representative card in the database and acquire information about a payment card that matches the information about the representative card.

Then, in an operation (4) of requesting a payment approval, the payment gateway server 300 may transmit a payment approval request including the information about the payment card to the card company server 400.

Accordingly, even when the affiliated store terminal 200 requests the payment approval using the representative card in the operation (1) of requesting the payment approval, the payment gateway server 300 may request the payment approval using the payment card other than the representative card in the operation (4) of requesting the payment approval.

The payment gateway server 300 may identify the card company of the payment card, and transmit the payment approval request to the identified card company.

For example, when a card A issued by a first card company is set as a payment card, the payment gateway server 300 may transmit the payment approval request to a server of the first card company server, and when a card B issued by a second card company is set as a payment card, the payment gateway server 300 may transmit the payment approval request to the second card company server.

Then, in an operation (5) of approving a payment, the card company server 400 may verify information about the payment card included in the payment approval request and perform a payment approval procedure, and when the payment approval is completed, may transmit a payment approval result to the affiliated store terminal 200 through the payment gateway server 300.

As described above, according to the embodiment of the present disclosure, a plurality of general cards previously issued to a user through a plurality of card companies are registered to connect the plurality of general cards to a representative card, so that a user may be provided with a payment service through the general card connected to the representative card, irrespective of the card companies, by only carrying the representative card and setting a payment card of the representative card, without carrying all the plurality of general cards previously issued to the user by the respective card companies, such that user convenience is improved.

It should be understood that the effects of the present disclosure are not limited to the above effects and include all effects that can be deduced from the detailed description of the present disclosure or the configuration of the present disclosure described in the claims.

The above description of the present disclosure is for illustrative purposes, and a person having ordinary skilled in the art should appreciate that other specific modifications may be easily made without departing from the technical spirit or essential features of the present disclosure. Therefore, the above embodiments should be regarded as illustrative rather than limitative in all aspects. For example, components that have been described as being a single unit may be embodied in a distributed form, and components that have been described as being distributed can be embodied in a combined form.

The scope of the present disclosure is not defined by the detailed description set forth above but by the accompanying claims of the present disclosure. It should also be understood that all changes or modifications derived from the definitions and scope of the claims and their equivalents fall within the scope of the present disclosure.

What is claimed is:

1. A method of relaying, by a payment gateway server, a payment using a representative card connected to a plurality of general cards, the method comprising steps of:
(a) acquiring card information of a card set as a payment card among the plurality of general cards connected to the representative card when a payment approval is requested using the representative card; and
(b) requesting the payment approval to a card company server using the acquired card information of the payment card and perform processing such that the payment approval made using the payment card is completed.

2. The method of claim 1, further comprising: before step (a), registering a plurality of general cards previously issued to a user through respective card companies to connect the plurality of general cards to the representative card.

3. The method of claim 1, further comprising: before step (a),
transmitting a list of the general cards connected to the representative card to a user terminal; and
when a card is selected from the list of the general cards, processing such that the selected card is set as the payment card.

4. The method of claim 1, wherein step (a) comprises verifying whether the card used for requesting the payment approval is the representative card, and when it is verified that the payment approval has been requested using the representative card, acquiring the information of the payment card.

5. The method of claim 1, wherein step (b) comprises identifying a card company of the payment card and requesting the payment approval to the identified card company.

6. A payment gateway server comprising:
a card information acquiring unit configured to acquire card information of a card set as a payment card among a plurality of general cards connected to a representative card when a payment approval is requested using the representative card; and
a payment approval requesting unit configured to request a payment approval to a card company server using the acquired card information of the payment card and to perform processing such that the payment approval made using the payment card is completed.

7. The payment gateway server of claim 6, further comprising a card connection registration unit configured to register a plurality of general cards previously issued to a user through respective card companies to connect the plurality of general cards to the representative card.

8. The payment gateway server of claim 6, further comprising a payment card setting unit configured to transmit a list of the general cards connected to the representative card to a user terminal, and when a card is selected from the list of the general cards, process such that the selected card is set as the payment card.

9. The payment gateway server of claim 6, wherein the card information acquisition unit verifies whether the card used for requesting the payment approval is the representative card and, when it is verified that the payment approval has been requested using the representative card, acquires the information of the payment card.

10. The payment gateway server of claim 6, wherein the payment approval requesting unit identifies a card company of the payment card and requests the payment approval to the identified card company.
